(19) United States
(12) Patent Application Publication
(10) Pub. No.: US 2015/0312020 A1
(43) Pub. Date: Oct. 29, 2015

(54) Apparatus for Synchronizing Clock Frequencies

(71) Applicant: ENDRESS+HAUSER GMBH+CO. KG, Maulburg (DE)

(72) Inventors: Walter Rombach, Rheinfelden (DE); Franco Ferraro, Schworstadt (DE); Armin Wernet, Rheinfelden (DE); Kaj Uppenkamp, Wehr (DE)

(21) Appl. No.: 14/649,258

(22) PCT Filed: Nov. 27, 2013
(86) PCT No.: PCT/EP2013/074891

§ 371 Date: Jun. 3, 2015

(30) Foreign Application Priority Data
Dec. 13, 2012 (DE) 10 2012 112 234.2

(51) Int. Cl. H04L 7/00

(52) U.S. Cl. CPC H04L 7/0008

(57) ABSTRACT

An apparatus for synchronizing the clock frequencies of a first electronics unit arranged on the primary side, and a second electronics unit arranged on the secondary side. Associated with the first electronics unit is a clock signal producer, which produces a clock signal having a reference clock frequency, wherein a transmission unit is provided between the first electronics unit and the second electronics unit. A first control unit is provided, which operates the transmission unit with a clock frequency, which amounts to a fraction of the reference clock frequency of the first electronics unit, wherein a second control unit is provided, which couples the clock frequency out to the secondary side and, based on the out-coupled clock frequency, produces for the second electronics unit a clock frequency, which is synchronous with the reference clock frequency of the first electronics unit.

The invention relates to an apparatus for synchronizing clock frequencies of a first electronics unit arranged on the primary side and a second electronics unit arranged on the secondary side.

Known from the state of the art are measuring devices for automation technology, which are equipped with two electronic units, which in many cases are galvanically isolated from one another. The primary side electronics unit is usually connected with the energy supply of the measuring device, while the secondary side electronics unit is associated with the sensor, respectively the actuator. For energy- and data transmission, usually one or a number of galvanically isolated interfaces are provided, which can be embodied inductively, capacitively or optically. Communication between the two electronic units occurs for example in the case of inductive coupling from the primary side to the secondary side via frequency modulation and in the reverse direction via load modulation, such as described in DE 10 2006 051 900 A1. Also, an amplitude modulation is known. Often, no or only a unidirectional communication occurs from the primary side to the secondary side via the galvanically isolated interface; a optocoupler serves for data transmission from the secondary side to the primary side.

As a rule, transmitted from the secondary side to the primary side measurement are data, which represent the process variable, while from the primary side to the secondary side, above all, parameter data or sensor-specific, identifying data are transmitted. For reasons of space, energy and cost, the number of interfaces between primary side and secondary side is, as a rule, reduced to a minimum. As a result, the transmission of data and therewith of information is only possible with constraints.

Usually, each of the two electrically isolated electronic units contains its own clock signal producer. From reasons of cost, the clocks in many cases do not involve quartz oscillators, but, instead, cost effective electronic circuits. Especially for automation technology, a number of disadvantages result:
increased costs due to the use of two oscillators, one on the primary side and one on the secondary side;
additional space requirement due to the use of two oscillators;
drift (in unfavorable conditions even in different directions) of the clock signals produced by the isolated oscillators: In many cases, the oscillators on the primary side and the secondary side are exposed to different environmental temperatures. Moreover, different requirements on the accuracy of the clock signal production are placed on the galvanically isolated oscillators on the primary side and the secondary side. In the most unfavorable case, consequently, an asynchronous communication via e.g. a UART interface can be completely unusable for automation technology due to the above mentioned disadvantages.

An object of the invention is to provide an apparatus for determining at least one process variable, wherein data exchange between primary side and secondary side is improved.

The object is achieved by features including that there is associated with the first electronics unit a clock signal producer, which produces a clock signal having a reference clock frequency. Provided between the first electronics unit and the second electronics unit is a transmission unit. Furthermore, a first control unit and a second control unit are provided, wherein the first control unit operates the transmission unit with a clock frequency, which amounts to a fraction of the reference clock frequency of the first electronics unit, and wherein the second control unit out-couples the clock frequency to the secondary side and based on the out-coupled clock frequency produces a clock frequency for the second electronics unit, which is synchronous with the reference clock frequency of the first electronics unit. By synchronizing the clock frequencies on the primary side and on the secondary side, data exchange via an asynchronous communication interface is possible at any time, and/or independently of the reigning environmental conditions.

By synchronizing the clock signals of the electronic units, the earlier mentioned disadvantages are eliminated. The synchronizing occurs via the clock signal of the transmission unit installed for galvanic isolation. The transmission unit is clocked by the electronics unit arranged on the primary side. From the transmitter clock signal, a synchronous clock signal is produced for the electronics unit on the secondary side.

Preferably, the present invention is applied in the case of an apparatus for determining and/or monitoring at least one process variable. Corresponding apparatuses for automation technology are manufactured and sold by the applicant in various embodiments. Especially in the case, in which the apparatuses are applied in an explosion-endangered environment, the primary side and the secondary side are galvanically isolated from one another. Arranged on the secondary side is a sensor element sensitive for the process variable to be measured or monitored; located on the secondary side is also the secondary side electronics unit, which provides a measurement signal representing the process variable. Often present on the primary side is the primary side electronics unit for evaluation of the measurement signal and for producing an output signal. The two electronic units are, such as already mentioned, galvanically isolated from one another. The process variable is, for example, fill level of a liquid or a bulk good in a container, density, viscosity, electrical conductivity, flow or pH-value of a medium of whatever kind.

In an advantageous further development of the apparatus of the invention, the transmission unit is so embodied that it transmits energy from the first electronics unit to the second electronics unit unidirectionally and data between the two electronic units unidirectionally or bidirectionally.

Moreover, it is provided that, in the case of data exchange between the first electronics unit and the second electronics unit, the communication is asynchronous.

In an advantageous embodiment, the transmission unit is a galvanic isolation, especially a DC/DC converter.

An advantageous form of embodiment of the apparatus of the invention provides that there is associated with the second electronics unit a synchronizer unit, which based on the out-coupled clock frequency produces for the second electronics unit a clock frequency, which equals the clock frequency of the first electronics unit or which amounts to a multiple of the clock frequency of the first electronics unit. Preferably, the synchronizing unit is a frequency locked loop, respectively a FLL.

The option, per synchronizer unit, especially per FFL, to produce a higher synchronous clock frequency, e.g. 50 kHz to 5 MHz, has the advantage of eliminating on the secondary side the external clock signal producer, which must have a relatively high accuracy. Moreover, a cost effective clock signal producer can be used on the primary side.

Furthermore, it is provided in connection with the invention that the first electronics unit is a microprocessor or a microcontroller, which is associated with a measurement transmitter or a control unit, and that the second electronics unit is a microprocessor or a microcontroller, which is associated with a sensor or actuator arranged removed from the measurement transmitter.

An advantageous further development of the invention provides that the sensor is a sensor, via which the fill level of a medium in a container, and/or the density of the medium and/or the viscosity of the medium, and/or the temperature of the medium is ascertained. Especially favorable is when the sensor is a vibronic sensor, in the case of which usually the frequency of an oscillatable element is evaluated. Vibronic sensors for fill level-, density- and/or viscosity measurement are manufactured and sold by the applicant under the marks LIQUIPHANT and SOLIPHANT in various embodiments. Of course, it can also be a capacitive probe. As, however, already mentioned in the introduction, the invention is not limited to any particular measuring devices or measuring device types, but, instead, can generally be applied in the case of mutually coupled microprocessors or microcontrollers, which are galvanically isolated from one another. Furthermore, the invention is also applicable in the case of devices (actuators), via which a manipulated variable is controlled.

The invention will now be explained in greater detail based on the drawing, the figures of which show as follows:

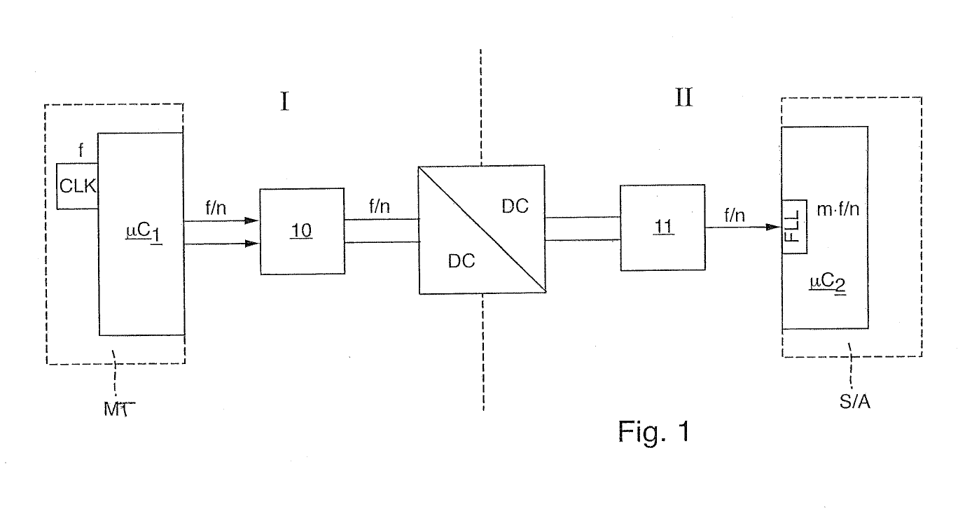

FIG. 1 a block diagram of a first embodiment of the apparatus of the invention, and

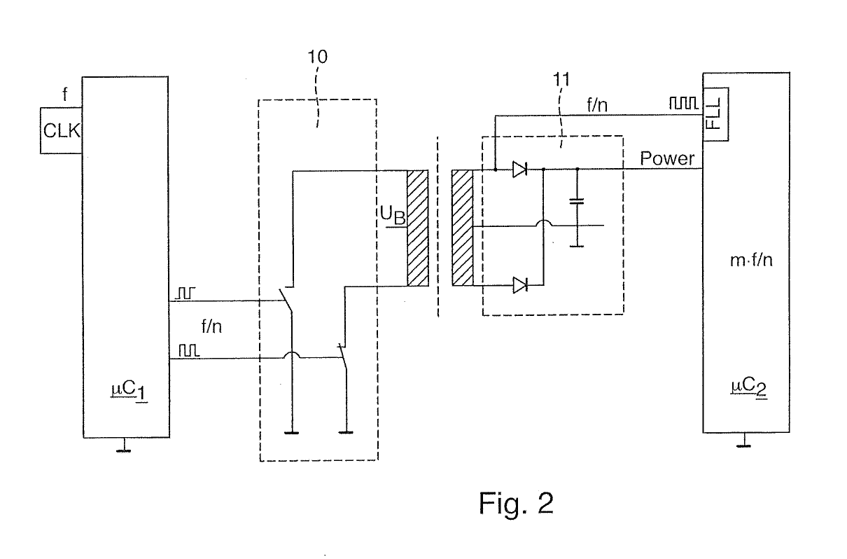

FIG. 2 the block diagram of FIG. 1 with additional details.

FIG. 1 shows a block diagram of a first embodiment of the apparatus of the invention for synchronizing the clock frequencies of a first electronics unit μC1 arranged on the primary side I and a second electronics unit μC2 arranged on the secondary side II. FIG. 2 shows other details of the circuit.

In the case of a measuring device determining and/or monitoring a process variable, the primary side electronics unit μC1, which is preferably a microprocessor or a microcontroller, is arranged in the measurement transmitter MT, while the secondary side electronics unit μC2, which is likewise preferably a microprocessor or a microcontroller, is arranged in the sensor S or in the actuator A. Data exchange between the two electronic units μC1, μC2 occurs via an asynchronous, and therewith strongly time dependent, communication.

Associated with the first electronics unit μC1 is an internal or alternatively an external, clock signal producer CLK. Due to the synchronizing of the clock frequencies of the electronic units μC1, μC2, this clock signal producer CLK does not need to be of high quality, i.e. neither does the tolerance of the produced clock frequency f need to be especially small, nor does the stability of the clock frequency over the allowable temperature range need to be especially high. In connection with the invention, thus a cost effective clock signal producer CLK can be used. For example, the clock signal producer CLK produces a clock frequency f from 1 MHz. In the primary side electronics unit μC1, the clock frequency f is divided down by a factor n, so that a clock signal with a reference frequency f/n is produced. The reference frequency f/n amounts to, for example, 50 kHZ or 100 kHz.

The two electronic units μC1, μC2 are galvanically isolated from one another. In the illustrated case, for the galvanic isolation, a transmission unit DC/DC is applied, which is a DC/DC converter. Preferably, the transmission unit DC/DC is so embodied that it transmits energy from the first electronics unit μC1 to the second electronics unit μC1 unidirectionally and data between the two electronic units μC1, μC2 unidirectionally or bidirectionally. Via the first control unit 10, which is a push-pull control, the transmission unit DC/DC is operated with the clock frequency f/n. The second control unit 11 couples the clock frequency f/n out to the secondary side II. The frequency locked loop FLL produces from the out-coupled clock frequency f/n, the converter clock signal, a fixed multiplier m, with which the second clock frequency m·f /n, with n, m=1, 2, . . . , for the second electronics unit μC2 is produced. The clock frequency m·f /n of the second electronics unit μC2 is synchronous with the clock frequency f and with the reference clock frequency f/n of the first electronics unit μC1. Preferably, the frequency locked loop FLL produces a higher synchronous clock frequency m·f /n for the secondary side electronics unit μC2. For example, the clock frequency m·f /n for the second microcontrollers is increased to 5 MHz. Of course, the clock frequency f of the second electronics unit μC2 can also be equal to the clock frequency f of the first electronics unit μC1.

As already described above, the solution of the invention permits the internal or external clock signal producer on the secondary side II, which usually must be of high quality, to be eliminated. This embodiment saves not only manufacturing costs but also space. Moreover, due to the synchronizing of the invention, a cost effective clock signal producer CLK can be applied on the primary side I, since the temperature loading of the electronics unit μC1 on the primary side I is usually much smaller than on the secondary side, thus on the process side. Furthermore, the solution of the invention has the advantage that the synchronizing of the clock frequencies of the first and second electronics unit μC1, μC2 occurs simultaneously with the transmission of data and energy/power. Especially, the data transmission is not interrupted by the synchronizing.

1-8. (canceled)

9. An apparatus having a primary side and a secondary side, for synchronizing the clock frequencies of a first electronics unit arranged on the primary side, and a second electronics unit arranged on the secondary side;
a clock signal producer associated with said first electronics unit, which produces a clock signal having a reference clock frequency;
a transmission unit provided between said first electronics unit and said second electronics unit;
a first control unit, which operates said transmission unit with the clock frequency, which amounts to a fraction of said reference clock frequency of said first electronics unit; and
a second control unit, which couples said clock frequency out to the secondary side and based on the out-coupled clock frequency produces for said second electronics unit a clock frequency (m·f /n, with m=1, 2, . . . ), which is synchronous with said reference clock frequency of said first electronics unit.

10. The apparatus as claimed in claim 9, wherein:
said transmission unit is so embodied that it transmits energy from said first electronics unit to said second electronics unit unidirectionally, and data between said two electronic units unidirectionally or bidirectionally.

11. The apparatus as claimed in claim 10, wherein:
data transmission between said first electronics unit and said second electronics unit is in the form of an asynchronous communication.

12. The apparatus as claimed in claim 9, wherein:
said transmission unit is a galvanic isolation, especially a DC/DC converter.

13. The apparatus as claimed in claim 9, wherein:
associated with said second electronics unit is a synchronizer unit, which based on said out-coupled clock frequency produces for said second electronics unit a clock frequency (m·f/n, with m=1, 2, . . . ), which equals the clock frequency of said first electronics unit or which amounts to a multiple of the clock frequency of said first electronics unit.

14. The apparatus as claimed in claim 9, wherein:
said first electronics unit is a microprocessor or a microcontroller, which is associated with a measurement transmitter; and
said second electronics unit is a microprocessor or a microcontroller, which is associated with a sensor or actuator arranged removed from said measurement transmitter.

15. The apparatus as claimed in claim 14, wherein:
said sensor is a sensor, via which fill level of a medium in a container, or density of the medium or viscosity of the medium, or temperature of the medium is ascertained.

16. The apparatus as claimed in claim 15, wherein:
said sensor is a vibronic sensor.
